(19) United States
(12) Patent Application Publication
(10) Pub. No.: US 2026/0219471 A1
(43) Pub. Date: Jul. 30, 2026

(54) A DEVICE FOR CLAMPING ANY OPHTHALMIC LENS

(71) Applicant: ESSILOR INTERNATIONAL, CHARENTON-LE-PONT (FR)

(72) Inventors: Sébastien DELLUC, CASTANET TOLOSAN (FR); Cédric LEMAIRE, SAINT-GERMAIN-EN-LAYE (FR); Serge GUGGENHEIM, THAON LES VOSGES (FR); Jean-Baptiste GERARD, THAON LES VOSGES (FR)

(21) Appl. No.: 19/146,114

(22) PCT Filed: Jan. 8, 2024
(86) PCT No.: PCT/EP2024/050301

§ 371 Date: Jul. 7, 2025

(30) Foreign Application Priority Data
Jan. 9, 2023 (EP) 23305022.8

(51) Int. Cl. G02B 7/02; B25B 5/14

(52) U.S. Cl. CPC G02B 7/026; B25B 5/14

(57) ABSTRACT

This device (10) for clamping any ophthalmic lens (12) including non-circular lenses, comprises: a supporting structure (14) having an opening (16) adapted for introducing a lens (12) therein; at least four arms (18) adapted to clamp the lens (12), each of the arms (18) being rotatable around a respective arm rotation shaft (180) fixed on the supporting structure (14) around the opening (16) and perpendicular to the arm (18) and to the supporting structure (14), the arms (18) being positioned so as to surround the opening (16), each of the arms (18) having an internal part (182) and an external part (184) opposite the internal part (182) with respect to the respective arm rotation shaft (180), the internal part (182) being closer than the external part (184) to a barycenter of the arms (18); a synchronization ring (20) having a respective link with the external part (184) of each of the arms (18) and being adapted to synchronize a movement of the arms (18).

### FIELD OF THE INVENTION

The present invention relates to a device for clamping any ophthalmic lens.

### BACKGROUND OF THE INVENTION

Some operations performed on ophthalmic lenses, such as cleaning by blowing, or cosmetic control, require the lens to be clamped by a dedicated device.

In addition, an operation like cleaning by blowing requires that the lens be securely maintained, without being broken in case it has a thin edge, while an operation like cosmetic control requires that the whole surface of both sides of the lens be visible, without being masked by any part of the clamping device.

Known clamping devices are unable to properly grip and clamp any lens shape, especially non-circular lenses, which is often the case in particular with lenses that were surfaced from a semi-finished lens. For example, as regards known grippers having several fingers for contacting the lens, not all fingers contact the lens when the lens is not circular, which causes weak clamping of the lens.

JP7147249 discloses a transport device for transporting spectacle lenses. U.S. Pat. No. 3,336,902 discloses a lens holder. ES2207470 discloses a device for centering and positioning a spectacle glass blank.

### SUMMARY OF THE INVENTION

An object of the present disclosure is to overcome the above-mentioned drawbacks of the prior art.

To that end, the present disclosure provides a device for clamping any ophthalmic lens including any semi-finished lens, any circular lens and any non-circular lens, wherein the device comprises:
a supporting structure having an opening adapted for introducing an ophthalmic lens therein;
at least four arms adapted to clamp the ophthalmic lens, each of the arms being rotatable around a respective arm rotation shaft fixed on the supporting structure around the opening and perpendicular to the arm and to the supporting structure, the arms being positioned so as to surround the opening, each of the arms having an internal part and an external part opposite the internal part with respect to the respective arm rotation shaft, the internal part being closer than the external part to a barycenter of the at least four arms;
a synchronization ring having a respective link with the external part of each of the arms, the synchronization ring being adapted to synchronize a movement of the arms while the arms move in a first direction.

Thus, thanks to the link between the synchronization ring and each of the arms, a self-centering system is provided which ensures that all arms securely clamp the ophthalmic lens even if it is not circular.

In an embodiment, the internal part and the external part of each of the at least four arms extend on a same face of the supporting structure. In this embodiment, the space axially required for the device according to the invention is reduced.

In an embodiment, the internal part and the external part of each of the at least four arms are formed in one piece. In this embodiment, the risk of decoupling the internal part and the external part of each of the at least four arms is reduced. In these embodiments the complexity of manufacturing the device according to the invention is reduced.

In an embodiment, the supporting structure is fixedly mounted relative to the device for clamping any ophthalmic lens. In this embodiment, the synchronization ring is mounted rotative relative to the supporting structure.

In an embodiment, the link between the synchronization ring and the external part of at least one of the arms includes a predetermined play allowing the at least one arm to stay immobile without immobilizing the synchronization ring for a predetermined displacement range of the synchronization ring. The predetermined play allows movements of each arm independently of the movement of each of the other arms.

In an embodiment, the link between the synchronization ring and the external part of the at least one of the arms comprises a limb joining the synchronization ring and the arm, the limb having a first end articulated to the synchronization ring by a ring-side junction and a second end articulated to the arm by an arm-side junction, the predetermined play resulting from a property of the limb to change shape within a predetermined tolerance when solicited in a predetermined direction.

In another embodiment, the link between the synchronization ring and the external part of the at least one arm comprises a limb joining the synchronization ring and the arm, the limb having a first end articulated to the synchronization ring by a ring-side junction and a second end articulated to the arm by an arm-side junction, each junction being adapted to allow a rotation of the first end with respect to the synchronization ring and a rotation of the second end with respect to the arm, the predetermined play being formed by at least one of the junctions and allowing a further movement of the limb having a translation component along a direction tangent to the synchronization ring.

In an embodiment, at least one of the junctions comprises a pin rotatable in a hole, the hole having at least two directions, the dimension of the hole in one of the at least two directions being greater than a thickness dimension of the pin. In an embodiment, the hole is an oblong hole of the synchronization ring.

In an embodiment, the synchronization ring is adapted to synchronize the rotation of all of the arms when the arms are rotating around their respective arm rotation shaft according to a closing movement bringing the internal parts of all of the arms closer to each other, the predetermined play enabling one or more of the at least one arm to stop rotating or to rotate at a slower pace than one or more other arms.

In an embodiment, the synchronization ring is further adapted to limit the closing movement of each of the arms, by rotating according to a predetermined rotation movement and wherein the at least one arm, when being impeded from rotating further according to the closing movement, is able to move relative to the synchronization ring in a direction opposite to the closing movement, according to the predetermined play.

In an embodiment, the external part of each of the arms is linked to the supporting structure through means adapted to apply on the external part an elastic return force bringing the internal part of each arm toward the center of the opening of the supporting structure. In an embodiment, means for applying the elastic return force are chosen among closing springs, pistons and compressible material having the same effect as the piston.

In one embodiment, the external part of each arm of the at least four arms cooperates individually with the synchronization ring. In this embodiment, the external part of each arm is provided with means adapted to apply the elastic return force. In this embodiment, each of the at least four arms are individually controlled. In this embodiment, each of the at least four arms is adapted to individually stop movement when contacting the ophthalmic lens and to continue movement despite any one or all of the other arms being blocked by contacting the ophthalmic lens. In this embodiment, the device of the invention allows individual movements of one arm independently of the other arms.

In an embodiment, the external part of each of the arms is linked to the supporting structure through a closing spring that is adapted to apply on the external part a force bringing the internal part of each arm closer to the external parts of the other arms in the closing movement. In this embodiment, each arm of the at least four arms is provided with an individual closing spring at the external part of each of the at least four arms.

In an embodiment, the predetermined play is included in the link between the synchronization ring and the external part of all of the arms.

In an embodiment, the device comprises five arms.

In an embodiment, the device comprises five arms or more. In this embodiment, the manufacturing of the device comprising five arms or more according to the invention is carried out without any significative change in the structure of the device, other than adding one or more arm(s) and distributing the arms on the supporting structure.

In an embodiment, the internal part of each of the arms has an end provided with a finger adapted to contact a peripheral edge of the ophthalmic lens, the finger extending in a direction parallel to the direction of the arm rotation shaft.

In an embodiment, each of the fingers is coated with a layer of elastic material.

In an embodiment, the layer of elastic material has a thickness between 2 mm and 5 mm included and each of the fingers has a diameter between 5 mm and 25 mm included.

In an embodiment, each of the fingers is a cylinder and at least one of the fingers, preferably all of the fingers, is rotatable around the axis of the cylinder.

In an embodiment, each of the arms has a C-shape such that when the finger is contacting the peripheral edge of the ophthalmic lens, the arm being provided with the finger does not overlap the surface of the ophthalmic lens.

To the same end as mentioned above, the present disclosure also provides a machine for optical observation of an ophthalmic lens, the machine comprising an observation lens, a light source and a device as succinctly described above, wherein the device is adapted to clamp the ophthalmic lens so as to position it between the observation lens and the light source without any overlapping between the device and the surface of the ophthalmic lens.

As particular features and advantages of the machine are similar to those of the device, they are not repeated here.

### BRIEF DESCRIPTION OF THE DRAWINGS

For a more complete understanding of the description provided herein and the advantages thereof, reference is now made to the brief descriptions below, taken in connection with the accompanying drawings and detailed description, wherein like reference numerals represent like parts.

FIG. 1 is a schematic view of a device according to the present disclosure, in a particular embodiment and in a final clamping position.

FIG. 2 is a schematic view showing the device of FIG. 1 in a first position.

FIG. 3 is a schematic view showing the device of FIG. 1 in a second position.

FIG. 4 is a schematic view showing the device of FIG. 1 in a third position.

FIG. 5 is a schematic simplified view of a machine according to the present disclosure, in a particular embodiment.

### DETAILED DESCRIPTION OF EMBODIMENTS

In the description which follows, the drawing figures are not necessarily to scale and certain features may be shown in generalized or schematic form in the interest of clarity and conciseness or for informational purposes. In addition, although making and using various embodiments are discussed in detail below, it should be appreciated that as described herein are provided many inventive concepts that may embodied in a wide variety of contexts. Embodiments discussed herein are merely representative and do not limit the scope of the invention. It will also be obvious to one skilled in the art that all the technical features that are defined relative to a process can be transposed, individually or in combination, to a device and conversely, all the technical features relative to a device can be transposed, individually or in combination, to a process.

The terms “comprise” (and any grammatical variation thereof, such as “comprises” and “comprising”), “have” (and any grammatical variation thereof, such as “has” and “having”), “contain” (and any grammatical variation thereof, such as “contains” and “containing”), and “include” (and any grammatical variation thereof such as “includes” and “including”) are open-ended linking verbs. They are used to specify the presence of stated features, integers, steps or components or groups thereof, but do not preclude the presence or addition of one or more other features, integers, steps or components or groups thereof. As a result, a method, or a step in a method, that “comprises”, “has”, “contains”, or “includes” one or more steps or elements possesses those one or more steps or elements, but is not limited to possessing only those one or more steps or elements.

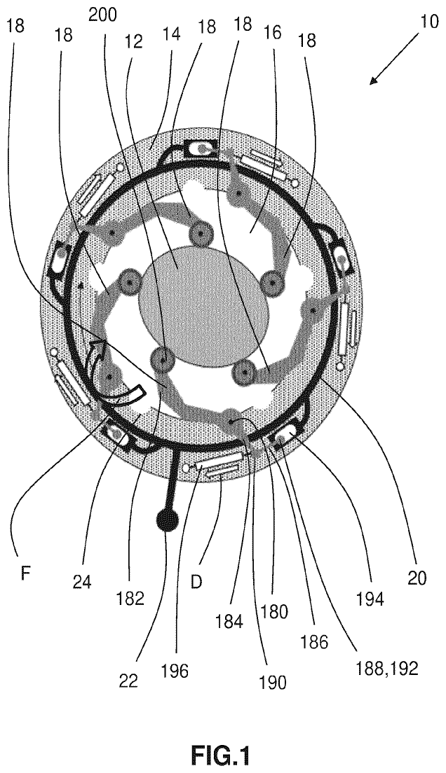

FIG. 1 shows a particular embodiment of a device 10 according to the present disclosure for clamping any ophthalmic lens 12. The considered ophthalmic lens 12 may be a semi-finished lens, a circular lens or a non-circular lens.

The device 10 comprises a supporting structure 14 having an opening 16 adapted for introducing the ophthalmic lens 12 therein. Thus, the size of the opening 16 is greater than the size of the ophthalmic lens 12.

By way of non-limiting example, the supporting structure 14 may be ring-shaped, as in the illustrated embodiment.

By way of non-limiting example, the supporting structure 14 may be made of brass.

According to the present disclosure, the device 10 further comprises at least four arms 18 and a synchronization ring 20.

In the illustrated embodiment, by way of non-limiting example, the device comprises five arms 18.

The arms 18 are adapted to clamp the ophthalmic lens 12.

Each arm 18 is rotatable around a respective arm rotation shaft 180 fixed on the supporting structure 14 around the opening 16. Each arm rotation shaft 180 is perpendicular to the arm 18 and to the supporting structure 14.

The arms 18 are positioned so as to surround the opening 16. By way of non-limiting example, the arm rotation shafts 180 may be distributed at equal intervals from each other on the supporting structure 14.

Each arm 18 has an internal part 182 and an external part 184 opposite the internal part 182 with respect to the arm rotation shaft 180 of the considered arm 18. The internal part 182 is closer than the external part 184 to the barycenter of the arms 18.

The internal part 182 of each of the arms 18 has an end, opposite to the arm rotation shaft 180, that is provided with a finger 200 adapted to contact the peripheral edge of the ophthalmic lens 12. The finger 200 extends in a direction parallel to the direction of the arm rotation shaft 180.

Advantageously, each of the fingers 200 may be coated with a layer of elastic material, such as butadiene-acrylonitrile.

By way of non-limiting example, the layer of elastic material may have a thickness between 2 mm and 5 mm included and each of the fingers 200 may have a diameter between 5 mm and 25 mm included, for example a thickness of elastic material of about 3 to 4 mm and a finger diameter of about 15 mm+2 mm, elastic material included.

In the illustrated embodiment, each of the fingers 200 is a cylinder. Advantageously, at least one of the fingers 200, preferably all of the fingers 200, is rotatable around the axis of that cylinder.

In the illustrated embodiment, each of the arms has an C-shape such that when the finger 200 is contacting the peripheral edge of the ophthalmic lens 12, the arm 18 being provided with that finger 200 does not overlap the surface of the ophthalmic lens 12.

The synchronization ring 20 has a respective link with the external part 184 of each arm 18. Thanks to that specific link that will be described in more detail below, the synchronization ring 20 is adapted to synchronize a movement of the arms 18 while the arms 18 move in a first direction resulting from their rotation around their respective arm rotation shaft 180 as indicated by the arrow F in FIG. 1.

The link between the synchronization ring 20 and the external part 184 of at least one of the arms 18 includes a predetermined play allowing that at least one arm 18 to stay immobile without immobilizing the synchronization ring 20 for a predetermined displacement range of the synchronization ring 20.

In the illustrated embodiment, there is a play in the link between the synchronization ring 20 and the external part 184 of all the arms 18.

In the illustrated embodiment, the link between the synchronization ring 20 and the external part 184 of the above-mentioned at least one arm 18 comprises a limb 186 joining the synchronization ring 20 and the arm 18.

The limb 186 has a first end articulated to the synchronization ring 20 by a ring-side junction 188 and a second end articulated to the arm 18 by an arm-side junction 190.

In an embodiment, the predetermined play may result from a property of the limb 186 to change shape i.e. to elongate or shorten within a predetermined tolerance when solicited in a predetermined direction.

As a variant, which is shown in FIG. 1, each junction 188, 190 may be adapted to allow a rotation of the first end of the limb 186 with respect to the synchronization ring 20 and a rotation of the second end of the limb 186 with respect to the arm 18, the predetermined play being formed by at least one of the junctions 188, 190 and allowing a further movement of the limb 186 having a translation component along a direction D tangent to the synchronization ring 20.

In such a variant, at least one of the junctions 188, 190 may comprise a pin 192 rotatable in a hole 194. The hole 194 may be located in the limb 186 or in the arm 18. The hole 194 is an oblong hole i.e. it has at least two directions, the dimension of the hole 194 in one of these at least two directions being greater than a thickness dimension of the pin 192.

Alternatively, the limb 186 may be formed of two elements that can rotate with each other and each with one of the junctions 188, 190. When it is in its elongated state, the limb 186 has a fixed length and when it is in its shortened state, the two elements of the limb 186 form an angle with each other, allowing the synchronization ring 20 and the arm 18 to move closer when the arm 18 is impeded from rotating.

Advantageously, the synchronization ring 20 is adapted to synchronize the rotation of all of the arms 18 when the arms 18 are rotating according to arrow F around their respective arm rotation shaft 180 according to a so-called closing movement bringing the internal parts 182 of all of the arms 18 closer to each other. The above-mentioned predetermined play enables one or more of the above-mentioned at least one arm 18 which benefits from that play to stop rotating or to rotate at a slower pace than one or more other arms for which no play is provided.

In the illustrated embodiment, the predetermined play is included in the link between the synchronization ring 20 and the external part 184 of all of the arms 18.

In the illustrated embodiment, the external part 184 of each of said arms 18 is linked to the supporting structure 14 through a closing spring 196.

The closing spring 196 is adapted to apply on the external part 184 a force bringing the internal part 182 of each arm 18 closer to the external parts 184 of the other arms 18 in the closing movement.

As a variant, the limbs 186 and/or the closing springs 196 may be replaced by pistons that push the arms 18. When an arm 18 contacts the peripheral edge of the ophthalmic lens 12, the contacting force overcomes the internal pressure of the piston replacing the limb and acts like a play.

As another variant, the limbs 186 and/or the closing springs 196 may be replaced by a bar of compressible material having the same effect as a piston.

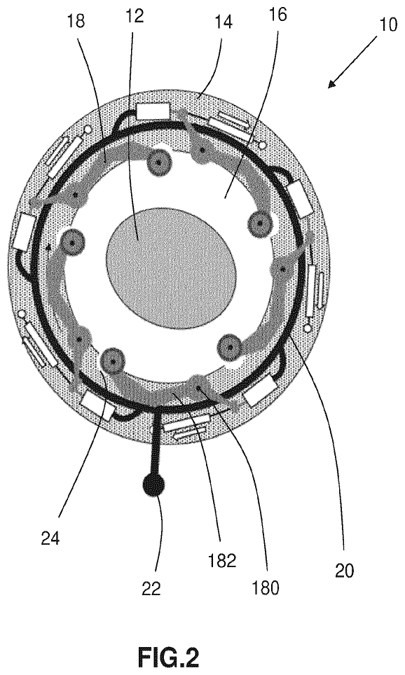

FIGS. 2 to 4 show a non-limiting example of successive states of the device 10 when the synchronization ring 20 is moved in clockwise rotation. In FIGS. 2 to 4, the plays are represented in a functional manner by symbolic rectangles, so that the holes 194 illustrated as oblong holes in FIG. 1 are not visible in FIGS. 2 to 4.

Rotation may be controlled either manually e.g. by means of a tab 22 (as in the illustrated embodiment), or automatically e.g. by means of a driving mechanism.

The state shown in FIG. 2 can be considered as an initial state, in which all of the arms 18 are at rest. Optionally, as shown in the illustrated embodiment, notches 24 may be provided in the supporting structure 14 so that at rest, the end of the internal part 182 of each arm 18 that is opposite to the arm rotating shaft 180 is accommodated in a respective notch 24. This makes it possible to make more room for the ophthalmic lens 12 to be introduced through the opening 16.

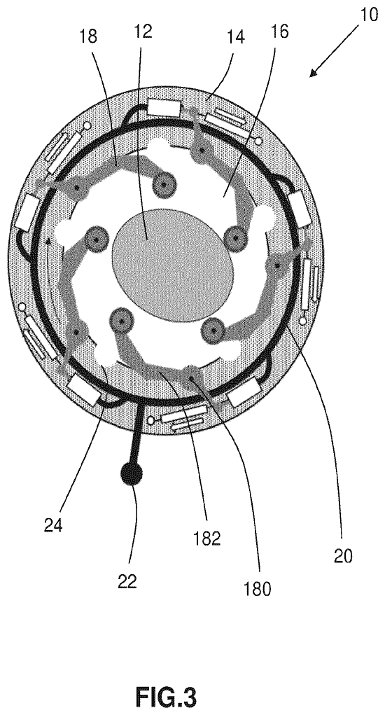

As shown in FIG. 3, the synchronization ring 20 has been moved in rotation so that all arms 18 have rotated around their respective arm rotation shaft 180 according to the closing movement and have left their respective notch 24. As by way of non-limiting example, the considered ophthalmic lens 12 is not circular, only one of the arms 18 is now in contact with the peripheral edge of the ophthalmic lens 12.

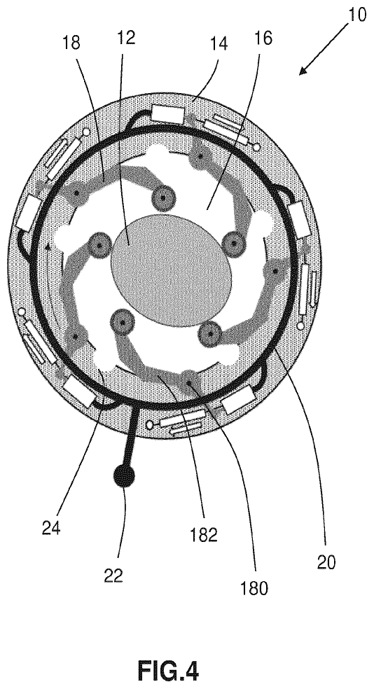

As shown in FIG. 4, the synchronization ring 20 has been further moved in rotation so that the arms 18 have rotated further around their respective arm rotation shaft 180 according to the closing movement, except the arm 18 that was already in contact with the peripheral edge of the ophthalmic lens 12. Now three arms 18 are in contact with the peripheral edge of the ophthalmic lens 12.

Namely, the synchronization ring is further adapted to limit the closing movement of any of the arms 18, by rotating according to a predetermined rotation movement and the at least one arm 18 provided with the predetermined play, when being impeded from rotating further according to the closing movement, is able to move relative to the synchronization ring 20 in a direction opposite to the closing movement, according to the predetermined play.

The state shown in FIG. 1 can be considered as a final state, in which all the arms 18 are in contact with the peripheral edge of the ophthalmic lens 12. This final state is reached after the arms 18 which were not yet in contact with the peripheral edge of the ophthalmic lens 12 have further rotated around their respective arm rotation shaft 180 according to the closing movement.

The present disclosure also provides a machine 50 for optical observation of the ophthalmic lens 12.

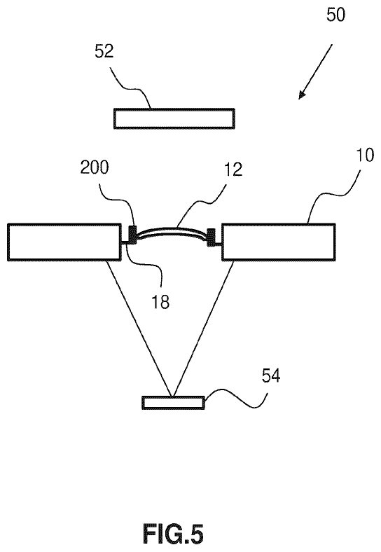

As shown in FIG. 5, the machine 50 comprises an observation lens 52, a light source 54 and the device 10.

The device 10 is adapted to clamp the ophthalmic lens 12 so as to position it between the observation lens 52 and the light source 54 without any overlapping between the device 10 and the surface of the ophthalmic lens 12.

This makes it possible to see the whole concave face and the whole convex face of the ophthalmic lens 12 without being disturbed by the clamping device 10. In addition, the degree of freedom on each finger 200 compensates the non-circular shape of the ophthalmic lens 12. Moreover, the clamping effort is distributed on all the fingers 200, thus reducing the risk of breaking the ophthalmic lens 12 in case it is very thin, while ensuring a secure gripping of the ophthalmic lens 12.

Although representative devices and machines have been described in detail herein, those skilled in the art will recognize that various substitutions and modifications may be made without departing from the scope of what is described and defined by the appended claims.

1. A device (10) for clamping any ophthalmic lens (12) including any semi-finished lens, any circular lens and any non-circular lens, wherein said device (10) comprises:
a supporting structure (14) having an opening (16) adapted for introducing an ophthalmic lens (12) therein;
at least four arms (18) adapted to clamp said ophthalmic lens (12), each of said arms (18) being rotatable around a respective arm rotation shaft (180) fixed on said supporting structure (14) around said opening (16) and perpendicular to said arm (18) and to said supporting structure (14), said arms (18) being positioned so as to surround said opening (16), each of said arms (18) having an internal part (182) and an external part (184) opposite said internal part (182) with respect to said respective arm rotation shaft (180), said internal part (182) being closer than said external part (184) to a barycenter of said at least four arms (18);
a synchronization ring (20) having a respective link with the external part (184) of each of said arms (18), said synchronization ring (20) being adapted to synchronize a movement of said arms (18) while said arms (18) move in a first direction.

2. A device (10) according to claim 1, wherein said link between said synchronization ring (20) and the external part of at least one of said arms (18) includes a predetermined play allowing said at least one arm (18) to stay immobile without immobilizing said synchronization ring (20) for a predetermined displacement range of said synchronization ring (20).

3. A device (10) according to claim 2, wherein said link between said synchronization ring (20) and the external part (184) of said at least one arm (18) comprises a limb (186) joining said synchronization ring (20) and said arm (18), said limb (186) having a first end articulated to said synchronization ring (20) by a ring-side junction (188) and a second end articulated to said arm (18) by an arm-side junction (190), said predetermined play resulting from a property of said limb (186) to change shape within a predetermined tolerance when solicited in a predetermined direction.

4. A device (10) according to claim 2, wherein said link between said synchronization ring (20) and the external part (184) of said at least one arm (18) comprises a limb (186) joining said synchronization ring (20) and said arm (18), said limb (186) having a first end articulated to said synchronization ring (20) by a ring-side junction (188) and a second end articulated to said arm (18) by an arm-side junction (190), each junction (188, 190) being adapted to allow a rotation of said first end with respect to said synchronization ring (20) and a rotation of said second end with respect to said arm (18), said predetermined play being formed by at least one of said junctions (188, 190) and allowing a further movement of said limb (186) having a translation component along a direction tangent to said synchronization ring (20).

5. A device (10) according to claim 4, wherein at least one of said junctions (188, 190) comprises a pin (192) rotatable in a hole (194), said hole (194) having at least two directions, the dimension of said hole (194) in one of said at least two directions being greater than a thickness dimension of said pin (192).

6. A device (10) according to claim 2, wherein said synchronization ring (20) is adapted to synchronize the rotation of all of said arms (18) when said arms (18) are rotating around their respective arm rotation shaft (180) according to a closing movement bringing the internal parts (182) of all of said arms (18) closer to each other, said predetermined play enabling one or more of said at least one arm (18) to stop rotating or to rotate at a slower pace than one or more other arms (18).

7. A device (10) according to claim 6, wherein said synchronization ring (20) is further adapted to limit said closing movement of each of said arms (18), by rotating according to a predetermined rotation movement and wherein said at least one arm (18), when being impeded from rotating further according to said closing movement, is able to move relative to said synchronization ring (20) in a direction opposite to said closing movement, according to said predetermined play.

8. A device (10) according to claim 6, wherein the external part (184) of each of said arms (18) is linked to said supporting structure (14) through a closing spring (196) that is adapted to apply on said external part (184) a force bringing the internal part (182) of each arm (18) closer to the external parts (184) of the other arms (18) in said closing movement.

9. A device (10) according to claim 2, wherein said predetermined play is included in said link between said synchronization ring (20) and the external part (184) of all of said arms (18).

10. A device (10) according to claim 1, wherein it comprises five arms (18).

11. A device (10) according to claim 1, wherein the internal part (182) of each of said arms (18) has an end provided with a finger (200) adapted to contact a peripheral edge of said ophthalmic lens (12), said finger (200) extending in a direction parallel to the direction of said arm rotation shaft (180).

12. A device (10) according to claim 11, wherein each of said fingers (200) is coated with a layer of elastic material.

13. A device (10) according to claim 12, wherein said layer of elastic material has a thickness between 2 mm and 5 mm included and each of said fingers (200) has a diameter between 5 mm and 25 mm included.

14. A device (10) according to claim 11, wherein each of said fingers (200) is a cylinder and at least one of said fingers (200), preferably all of said fingers (200), is rotatable around the axis of said cylinder.

15. A machine (50) for optical observation of an ophthalmic lens (12), said machine (50) comprising an observation lens, a light source and a device (10) according to claim 1, wherein said device (10) is adapted to clamp said ophthalmic lens (12) so as to position it between said observation lens and said light source without any overlapping between said device (10) and the surface of said ophthalmic lens (12).
